(19) United States
(12) Patent Application Publication
(10) Pub. No.: US 2007/0217222 A1
(43) Pub. Date: Sep. 20, 2007

(54) SURFACE LIGHT SOURCE DEVICE AND BACKLIGHT UNIT HAVING THE SAME

(75) Inventors: Kyeong Taek Jung, Suwon-si (KR); Kyu Dong Lee, Suwon-si (KR); Hyung Bin Youn, Suwon-si (KR)

Correspondence Address: BEYER WEAVER LLP, P.O. BOX 70250, OAKLAND, CA, 94612-0250, US

(73) Assignee: SAMSUNG CORNING CO., LTD., Suwon-si (KR)

(21) Appl. No.: 11/685,967

(22) Filed: Mar. 14, 2007

(30) Foreign Application Priority Data
Mar. 16, 2006 (KR) 10-2006-0024135

(51) Int. Cl. F21V 7/04

(52) U.S. Cl. 362/614

(57) ABSTRACT

There is provided a surface light source device, including: a light source body having a first substrate and a second substrate between which a plurality of discharge spaces are formed, a discharge gas being provided into the discharge spaces; a reflecting layer formed on an inner surface of the first substrate; a first adsorption preventing layer formed on the reflecting layer, for preventing the discharge gas from being adsorbed to the reflecting layer; a first fluorescent layer formed on the first adsorption preventing layer; a second fluorescent layer formed on an inner surface of the second substrate; and an electrode applying a discharge voltage to the discharge gas. Accordingly, since the discharge gas is uniformly distributed in the discharge spaces, the surface light source device has improved brightness uniformity.

### CROSS-REFERENCE TO RELATED APPLICATION

This application claims the benefit of Korean Patent Application No. 2006-0024135, filed on Mar. 16, 2006, the disclosure of which is hereby incorporated herein by reference in its entirety.

### BACKGROUND OF THE INVENTION

1. Technical Field

The present invention relates to a surface light source device and a backlight unit having the same, and more particularly, to a surface light source device having improved brightness uniformity and a backlight unit having the surface light source device as a light source.

2. Discussion of Related Art

In general, liquid crystal (LC) has an electrical characteristic and an optical characteristic. Arrangement of the LC is changed according to a direction of an electric field by the electrical characteristic, and light transmittance of the LC is changed according to the arrangement by the optical characteristic.

A liquid crystal display (LCD) device displays an image, using the electrical characteristic and the optical characteristic of liquid crystal. Since the LCD device is very small in size and light in weight, compared to a cathode-ray tube (CRT) device, it is widely used for portable computers, communication products, liquid crystal television (LCTV) receivers, aerospace industry, and the like.

The LCD device needs a liquid crystal controlling part for controlling the LC, and a light supplying part for supplying a light to the LC.

The liquid crystal controlling part includes a plurality of pixel electrodes disposed at a first substrate, a single common electrode disposed at a second substrate, and liquid crystal interposed between the pixel electrodes and the common electrode. A number of pixel electrodes are used for the resolution of the LCD device, and the single common electrode is placed in opposite to the pixel electrodes. Each pixel electrode is connected to a thin film transistor (TFT) so that each different pixel voltage is applied to the pixel electrode. An equal level of a reference voltage is applied to the common electrode. The pixel electrodes and the common electrode are made of a transparent conductive material.

The light supplying part supplies a light to the LC of the liquid crystal controlling part. The light passes through the pixel electrodes, the LC and the common electrode sequentially. The display quality of an image passing through the LC significantly depends on brightness and brightness uniformity of the light supplying part. Generally, as the brightness and brightness uniformity are high, the display quality is improved.

In a conventional LCD device, the light supplying part generally uses a cold cathode fluorescent lamp (CCFL) which has a bar shape, or a light emitting diode (LED) which has a dot shape. The CCFL has high brightness and long life of use and generates a small amount of heat, compared to an incandescent lamp. The LED has high brightness. However, in the conventional CCFL or LED, the brightness uniformity is weak.

Therefore, to increase the brightness uniformity, the light supplying part, which uses the CCFL or LED as a light source, needs optical members, such as a light guide panel (LGP), a diffusion member and a prism sheet. Consequently, the LCD device using the CCFL or LED becomes large in size and heavy in weight due to the optical members.

To solve the aforementioned problems, a surface light source device in a flat panel shape has been suggested. Conventional surface light source devices are divided into a surface light source device in which a plurality of discharge spaces are formed by independent partitions (hereinafter, referred to as ‘independent partition type surface light source device’) and a surface light source device in which a plurality of discharge spaces are formed by integrated partitions integrally formed on a corrugated substrate (hereinafter, referred to as ‘integrated partition type surface light source device’).

The conventional independent partition type surface light source device includes a first substrate, a second substrate positioned above the first substrate, and a sealing member, positioned between the edges of the first and second substrates, for defining an inner surface. Independent partitions are positioned in the inner space, thereby dividing the inner space into a plurality of discharge spaces into which a discharge gas including a mercury gas is injected. A fluorescent layer is formed on the inner surfaces of the first and second substrates. An electrode for applying a voltage to the discharge gas is formed, along both edges of the outer surfaces of the first and second substrates. Further, a reflecting layer is interposed between the first substrate and the fluorescent layer.

The conventional integrated partition type surface light source device includes a first substrate and a second substrate positioned on the first substrate. The second substrate is corrugated to form a plurality of integrated partitions. The partitions contact with the first substrate, thereby forming a plurality of discharge spaces into which a discharge gas is injected. An edge of the second substrate is bonded to the first substrate by frit for sealing. A fluorescent layer is formed on the inner surfaces of the first and second substrates. An electrode for applying a voltage to the discharge gas is formed along the edges of the outer surfaces of the first and second substrates. Further, a reflecting layer is interposed between the first substrate and the fluorescent layer.

Here, the mercury gas contained in the discharge gas is very sensitive to a temperature. That is, the mercury gas flows towards a place where a temperature is relatively low, rather than evenly diffusing.

In the aforementioned surface light source devices, an area of the discharge space adjacent to the second substrate from which the light is emitted has a lower temperature than an area of the discharge space adjacent to the first substrate. Thus, the mercury gas moves to the area adjacent to the second substrate. The mercury gas which moves towards the low temperature place is physically adsorbed to the reflecting layer and the fluorescent layer. Consequently, the mercury gas exists relatively much more at the area adjacent to the second substrate than the area adjacent to the first substrate. Since the mercury gas is nonuniformly distributed in the discharge spaces, the brightness uniformity of the surface light source device seriously deteriorates.

Moreover, in the conventional surface light source devices, since the substrate is directly in contact with the fluorescent layer, natrium ions contained in the substrate are eluted to the fluorescent layer, causing a serious blackening phenomenon of the surface light source device.

### SUMMARY OF THE INVENTION

Therefore, the present invention is directed to provide a surface light source device which prevents a mercury gas, which flows towards an area of a discharge space having a relatively low temperature, from being adsorbed to a reflecting layer and a fluorescent layer and which prevents natrium ions contained in a substrate from being eluted to the fluorescent layer.

Another object of the present invention is to provide a backlight unit having the aforementioned surface light source device as a light source.

In accordance with an aspect of the present invention, the present invention provides a surface light source device including: a light source body having a first substrate and a second substrate between which a plurality of discharge spaces are formed, a discharge gas being provided into the discharge spaces; a reflecting layer formed on an inner surface of the first substrate; a first adsorption preventing layer formed on the reflecting layer, for preventing the discharge gas from being adsorbed to the reflecting layer; a first fluorescent layer formed on the first adsorption preventing layer; a second fluorescent layer formed on an inner surface of the second substrate; and an electrode applying a discharge voltage to the discharge gas.

In accordance with an exemplary embodiment of the present invention, a second adsorption preventing layer may be formed on the first fluorescent layer, for preventing the discharge gas from being adsorbed to the first fluorescent layer. Further, the first adsorption preventing layer may have a greater thickness than the second adsorption preventing layer. Further, an elution preventing layer may be interposed between the second fluorescent layer and the second substrate, for preventing a metal contained in the second substrate from being eluted to the second fluorescent layer.

In accordance with another aspect of the present invention, the present invention provides a surface light source device including: a light source body having a first substrate and a second substrate between which a plurality of discharge spaces are formed, a discharge gas being provided into the discharge spaces; a reflecting layer formed on an inner surface of the first substrate; a compound fluorescent layer formed on at least any one of the reflecting layer and an inner surface of the second substrate, the compound fluorescent layer composed of a fluorescent substance and an adsorption preventing material; and an electrode applying a discharge voltage to the discharge gas.

In accordance with another aspect of the present invention, the present invention provides a backlight unit including: a surface light source device, including a light source body having a first substrate and a second substrate between which a plurality of discharge spaces are formed, a discharge gas being provided into the discharge spaces, a reflecting layer formed on an inner surface of the first substrate, a first adsorption preventing layer formed on the reflecting layer, for preventing the discharge gas from being adsorbed to the reflecting layer, a first fluorescent layer formed on the first adsorption preventing layer, a second fluorescent layer formed on an inner surface of the second substrate, and an electrode applying a discharge voltage to the discharge gas; a case for receiving the surface light source device; an optical sheet interposed between the surface light source device and the case; and an inverter for supplying the discharge voltage for driving the surface light source device to the electrode.

In accordance with the above-described present invention, the adsorption preventing layer prevents the discharge gas from being physically adsorbed to the reflecting layer and the fluorescent layers. Therefore, even though the discharge gas flows towards one side of the discharge space due to a temperature difference, the discharge gas is not adsorbed to the reflecting layer and the fluorescent layers. Further, the elution preventing layer prevents the natrium ions contained in the substrate from being eluted to the fluorescent layers. Consequently, the discharge gas is uniformly distributed within the discharge space and thus, the surface light source device has improved brightness uniformity.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating a surface light source device according to a first embodiment of the present invention;

FIG. 2 is a sectional view taken along Line II-II of FIG. 1;

FIG. 3 is a sectional view illustrating a surface light source device according to a second embodiment of the present invention;

FIG. 4 is an enlargement of Part IV of FIG. 3;

FIG. 5 is a perspective view illustrating a surface light source device according to a third embodiment of the present invention;

FIG. 6 is a sectional view taken along Line VI-VI of FIG. 5;

FIG. 7 is an exploded perspective view illustrating a backlight unit according to a fourth embodiment of the present invention;

FIG. 8A is a picture showing the initial brightness of a surface light source device according to a first experimental example;

FIG. 8B is a picture showing the initial brightness of a surface light source device according to a second experimental example;

FIG. 8C is a picture showing the initial brightness of a surface light source device according to a comparative example;

FIG. 9A is a picture showing the brightness of the surface light source device according to the first experimental example, after 100 hours;

FIG. 9B is a picture showing the brightness of the surface light source device according to the second experimental example, after 100 hours;

FIG. 9C is a picture showing the brightness of the surface light source device according to the comparative example, after 100 hours;

FIG. 10A is a picture showing the brightness of the surface light source device according to the first experimental example, after 200 hours;

FIG. 10B is a picture showing the brightness of the surface light source device according to the second experimental example, after 200 hours;

FIG. 10C is a picture showing the brightness of the surface light source device according to the comparative example, after 200 hours;

FIG. 11A is a picture showing the brightness of the surface light source device according to the first experimental example, after 300 hours;

FIG. 11B is a picture showing the brightness of the surface light source device according to the second experimental example, after 300 hours;

FIG. 11C is a picture showing the brightness of the surface light source device according to the comparative example, after 300 hours;

FIG. 12A is a picture showing the brightness of the surface light source device according to the first experimental example, after 500 hours;

FIG. 12B is a picture showing the brightness of the surface light source device according to the second experimental example, after 500 hours; and

FIG. 12C is a picture showing the brightness of the surface light source device according to the comparative example, after 500 hours.

### DETAILED DESCRIPTION OF THE INVENTION

The present invention will now be described more fully hereinafter with reference to the accompanying drawings, in which preferred embodiments of the invention are shown.

### Embodiment 1

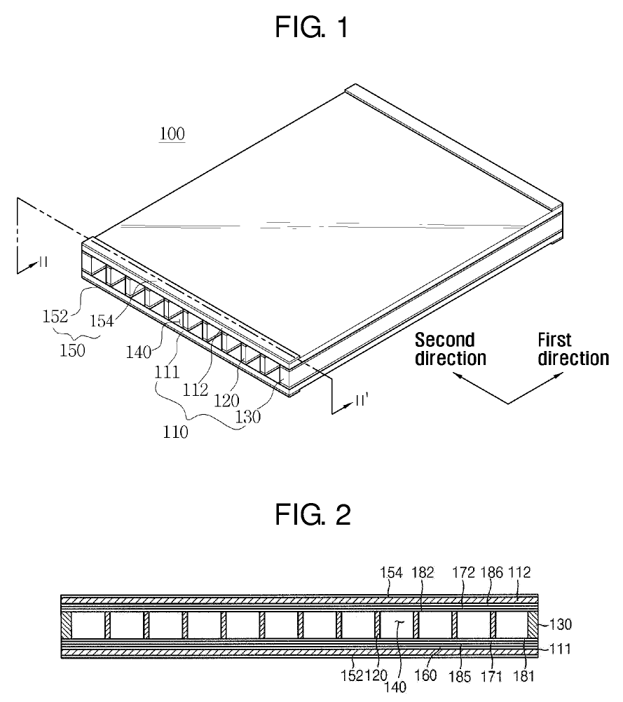

FIG. 1 is a perspective view illustrating a surface light source device 100 according to a first embodiment of the present invention, and FIG. 2 is a sectional view taken along Line II-II of FIG. 1.

In FIGS. 1 and 2, the surface light source device 100 includes a light source body having an internal space into which a discharge gas is injected, and an electrode 150 for applying a discharge voltage to the discharge gas. The discharge gas may include at least one of mercury gas, argon gas, neon gas, xenon gas, and the like.

The surface light source device 100 is an independent partition type in which a plurality of discharge spaces is formed by independent partitions. Therefore, the light source body comprises a first substrate 111, a second substrate 112 positioned above the first substrate 111, a sealing member 130, positioned between edges of the first and second substrates 111 and 112, for defining the internal space, and partitions 120 for partitioning the internal space into a plurality of discharge spaces 140.

The first and second substrates 111 and 112 are made of a glass material which allows a visible light to pass but blocks an ultraviolet light. The second substrate 112 is a light emitting surface from which the light generated in the discharge spaces 140 is emitted.

The partitions 120 are arranged in parallel in the internal space, along a first direction, thereby partitioning the internal space into the plurality of discharge spaces 140 in a stripe shape. A bottom surface of the partitions 120 is in contact with the first substrate 111, and a top surface of the partitions 120 is in contact with the second substrate 112. To inject the discharge gas into each discharge space 140, the partitions 120 may be arranged in a serpentine structure or a passage hole (not shown) may be formed in the partitions 120.

The electrode 150 includes a first electrode 152 formed at the bottom surface of the first substrate 111 and a second electrode 154 formed at the top surface of the second substrate 112. Specifically, the first and second electrodes 152 and 154 are disposed at both edges of the first and second substrates 111 and 112, along a second direction which is substantially at right angles to the first direction. The electrode 150 may be formed using a conductive tape or conductive paste.

A reflecting layer 160 is formed on the top surface of the first substrate 111. The reflecting layer 160 allows a light towards the first substrate 111, among the light generated in the discharge spaces, to be reflected towards the second substrate 112.

A first fluorescent layer 171, which is excited by the ultraviolet light generated from the discharge gas when a discharge voltage is applied, is formed on the reflecting layer 160. A second fluorescent layer 172 having the same function as the first fluorescent layer 171 is formed on the bottom surface of the second substrate 112.

An area of the discharge space 140 adjacent to the second substrate 112 from which a light is emitted has a lower temperature than an area of the discharge space 140 adjacent to the first substrate 111. Therefore, the mercury gas flows towards the area of the discharge space 140 adjacent to the second substrate 112. The mercury gas, which flows towards one side, is likely to be physically adsorbed to the reflecting layer 160 and the first and second fluorescent layers 171 and 172. Since the adsorbed mercury gas cannot move any more, the mercury gas is collected at the area of the discharge spaces 140 having a low temperature and thus, the brightness uniformity of light generated from the surface light source device 100 becomes worse.

To prevent these problems, a first adsorption preventing layer 185 is interposed between the reflecting layer 160 and the first fluorescent layer 171. Further, a second adsorption preventing layer 181 and a third adsorption preventing layer 182 are formed on the first fluorescent layer 171 and the second fluorescent layer 172 respectively. The first adsorption preventing layer 185 prevents the mercury gas from reacting with the reflecting layer 160, thereby preventing mercury from being physically adsorbed to the reflecting layer 160. The second and third adsorption preventing layers 181 and 182 prevent the mercury gas from reacting with the first and second fluorescent layers 171 and 172, thereby preventing mercury from being physically adsorbed to the fluorescent substance. In the first embodiment, the second adsorption preventing layer 181 and the third adsorption preventing layer 182 are formed on the first fluorescent layer 171 and the second fluorescent layer 172 respectively. However, without the second adsorption preventing layer 181, only the third adsorption preventing layer 182 may be formed on the second fluorescent layer 172 to which most of the mercury gas is adsorbed.

The first to third adsorption preventing layers 185, 181 and 182 may be made of, for example, metal oxide. Examples of the metal oxide include alumina, zirconia, tintania, yttria, or a combination of these.

The first adsorption preventing layer 185 may be thicker than the second adsorption preventing layer 181. Specifically, the first adsorption preventing layer 185 may be about 2 μm in thickness, and the second adsorption preventing layer 181 may be about 1 μm in thickness.

Further, the thickness of each of the second and third adsorption preventing layers 181 and 182 may have 20% or less of the thickness of each of the first and second fluorescent layers 171 and 172. Specifically, the second and third adsorption preventing layers 181 and 182 may be 10 nm to 10 μm, preferably, 10 nm to 0.5 μm, in thickness.

An elution preventing layer 186 is interposed between the second substrate 112 and the second fluorescent layer 172, for preventing the natrium ions contained in the second substrate 112 from being eluted to the second fluorescent layer 172. A material usable for the elution preventing layer 186 may be any one of the materials exemplified as the material of the third adsorption preventing layer 182.

In accordance with the first embodiment, the first adsorption preventing layer 185 prevents the mercury gas from being physically adsorbed to the reflecting layer 160. Further, the second and third adsorption preventing layers 181 and 182 prevent the mercury gas from being physically adsorbed to the first and second fluorescent layers 171 and 172. Accordingly, even though the mercury gas flows towards the low temperature place rather than uniformly diffuses, under the influence of a temperature difference in the discharge spaces 140, the mercury gas is prevented from being physically adsorbed to the reflecting layer 160 and the first and second fluorescent layers 171 and 172. Thus, if there is no temperature difference in the discharge spaces 140, the mercury gas is uniformly distributed in the discharge spaces 140. Further, the elution preventing layer 186 prevents the natrium ions contained in the second substrate 112 from being eluted to the second fluorescent layer 172, thereby preventing the blackening phenomenon of the surface light source device 100. Consequently, the surface light source device 100 has improved brightness uniformity.

### Embodiment 2

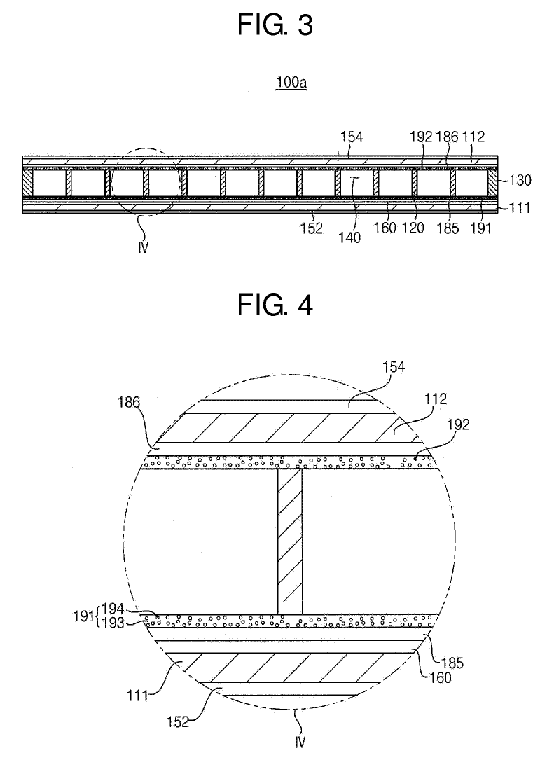

FIG. 3 is a sectional view illustrating a surface light source device 100a according to a second embodiment of the present invention, and FIG. 4 is an enlargement of Part IV of FIG. 3.

The surface light source device 100a of the second embodiment includes the substantially same constituting elements as those of the surface light source device 100 of the first embodiment, except for compound florescent layers 191 and 192. Accordingly, the same constituting elements are indicated by the same reference numerals, and no description of the same constituting elements will be presented below.

In FIGS. 3 and 4, a first compound fluorescent layer 191 is formed on a reflecting layer 160. Further, a second compound fluorescent layer 192 is formed on the bottom surface of a second substrate 112.

The first and second compound fluorescent layers 191 and 192 are formed using slurry manufactured by mixing a fluorescent substance 193 and an adsorption preventing material 194. The adsorption preventing material 194 prevents a mercury gas from being physically adsorbed to the reflecting layer 160 and the fluorescent substance 193. Examples of the adsorption preventing material 194 include alumina, zirconia, titania, yttria, or a combination of these.

In accordance with the second embodiment, since the fluorescent substance 193 and the adsorption preventing material 194 are included in the compound fluorescent layers 191 and 192, a process of coating the first to third adsorption preventing layers 185, 181 and 182 of the first embodiment is not needed.

### Embodiment 3

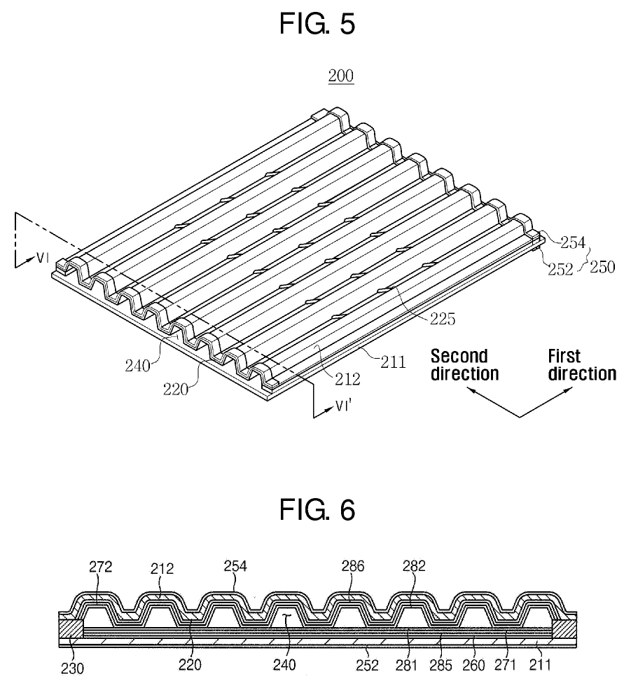

FIG. 5 is a perspective view illustrating a surface light source device 200 according to a third embodiment of the present invention, and FIG. 6 is a sectional view taken along Line VI-VI of FIG. 5.

In FIGS. 5 and 6, the surface light source device 200 includes a light source body having an internal space into which a discharge gas is injected, and an electrode 250 for applying a discharge voltage to the discharge gas.

The surface light source device 200 is an integrated partition type in which a plurality of discharge spaces are formed by integrated partitions integrally formed on a corrugated substrate.

The light source body includes a first substrate 211, and a second substrate 212 disposed on the first substrate 211 on which partitions 220 are integrally formed. The partitions 220 are arranged, along a first direction. The partitions 220 are in contact with the first substrate 211, forming a plurality of discharge spaces 240 in an approximately arch shape. To inject the discharge gas into each discharge space 240, the partitions 220 may be arranged in a serpentine structure or a passage hole 225 may be formed through the partitions 220. Specifically, the passage hole 225 may be formed through the partitions 220 in an oblique line or in an S-shape line. The partitions 220 according to the embodiment of the present invention have an about 1 to 5 mm width.

The electrode 250 is disposed, along both edges of the light source body in a second direction which is substantially at right angles to a first direction. The electrode 250 includes a first electrode 252 formed at the bottom surface of the first substrate 211 and a second electrode 254 formed at the top surface of the second substrate 212.

A reflecting layer 260 is formed on the top surface of the first substrate 211. A first fluorescent layer 271 is formed on the reflecting layer 260. A second fluorescent layer 272 is formed on the bottom surface of the second substrate 212.

A first adsorption preventing layer 285 is interposed between the reflecting layer 260 and the first fluorescent layer 271. A second adsorption preventing layer 281 is formed on the first fluorescent layer 271. Further, a third adsorption preventing layer 282 is formed on the second fluorescent layer 272. The first, second and third adsorption preventing layers 285, 281 and 282 respectively prevent the mercury gas from reacting with the reflecting layer 260 and the first and second fluorescent layers 271 and 272, thereby preventing mercury from being physically adsorbed to the reflecting layer 260 and the first and second fluorescent layers 271 and 272. Examples of the first to third adsorption preventing layers 285, 281 and 282 may include alumina, zirconia, titania, yttria, or a combination of these.

The first adsorption preventing layer 285 may be thicker in thickness than the second adsorption preventing layer 281. Specifically, the first adsorption preventing layer 285 may be about 2 μm in thickness, and the second adsorption preventing layer 281 may be about 1 μm in thickness.

Further, the thickness of each of the second and third adsorption preventing layers 281 and 282 may have 20% or less of the thickness of each of the first and second fluorescent layers 271 and 272. Specifically, the second and third adsorption preventing layers 281 and 282 may be 10 nm to 10 μm, preferably, 10 nm to 0.5 μm, in thickness.

An elution preventing layer 286 is interposed between the second substrate 212 and the second fluorescent layer 272, for preventing the natrium ions contained in the second substrate 212 from being eluted to the second fluorescent layer 272.

The compound fluorescent layers 191 and 192 of the second embodiment illustrated in FIG. 3 may be applied to the surface light source device 200 of the third embodiment of the present invention.

### Embodiment 4

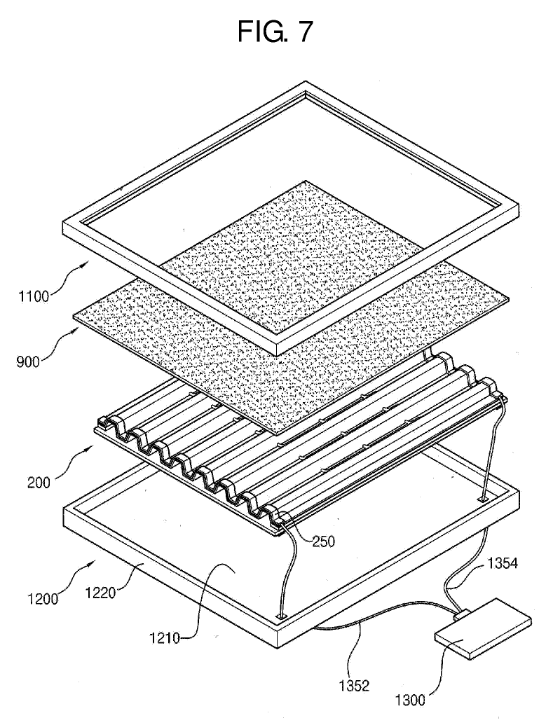

FIG. 7 is an exploded perspective view illustrating a backlight unit 1000 according to a fourth embodiment of the present invention.

In FIG. 7, the backlight unit 1000 includes the surface light source device 200 according to the third embodiment, upper and lower cases 1100 and 1200, an optical sheet 900, and an inverter 1300.

Since the surface light source device 200 has the substantially same structure as that illustrated in FIG. 5, no further description of the surface light source device 200 will be presented below. The other surface light source devices according to the aforementioned first and second embodiments may be applied to the backlight unit 1000.

To receive the surface light source device, the lower case 1200 has a bottom part 1210 and a plurality of sidewall parts 1220 which are extended from the periphery of the bottom part 1210 to form a receiving space. The surface light source device 200 is received in the receiving space of the lower case 1200.

The inverter 1300 is positioned at the rear surface of the lower case 1200 and generates a discharge voltage to drive the surface light source device 200. The discharge voltage generated by the inverter 1300 is supplied to the electrodes 250 of the surface light source device 200 through first and second power lines 1352 and 1354.

The optical sheet 900 may include a diffusion plate (not shown) for uniformly diffusing the light emitted from the surface light source device 200, and a prism sheet (not shown) for providing linearity to the diffused light.

The upper case 1100 is connected to the lower case 1200 and fixes the surface light source device 200 and the optical sheet 900. The upper case 1100 prevents the surface light source device 200 from leaving from the lower case 1200.

A liquid crystal display panel (not shown) for displaying an image may be positioned above the upper case 1100.

### Manufacture of Surface Light Source Device

### Experimental Example 1

A reflecting layer of 150 μm in thickness is formed on a first substrate. A first adsorption preventing layer, which is made of an yttria material and is 5 μm in thickness, is formed on the reflecting layer. Subsequently, a first florescent layer of 40 μm in thickness is formed on the first adsorption preventing layer. An elution preventing layer, which is made of the yttria material and is 5 μm in thickness, is formed on the bottom surface of a second substrate. Then, a second fluorescent layer of 20 μm in thickness is formed on the elution preventing layer. Second and third adsorption preventing layers, which is made of the yttria material and is 5 μm in thickness, are formed on the first and second fluorescent layers respectively.

### Experimental Example 2

A reflecting layer of 150 μm in thickness is formed on a first substrate. A first florescent layer of 40 μm in thickness is formed on the reflecting layer. A second florescent layer of 20 μm in thickness is formed on the bottom surface of a second substrate. An yttria layer of 5 μm in thickness is formed on the second florescent layer only.

### Experimental Example 3

A reflecting layer of 150 μm in thickness is formed on a first substrate. A first adsorption preventing layer, which is made of an yttria material and is 5 μm in thickness, is formed on the reflecting layer. A first florescent layer of 40 μm in thickness is formed on the first adsorption preventing layer. A second florescent layer of 20 μm in thickness is formed on the bottom surface of a second substrate. A second adsorption preventing layer, which is made of the yttria material and is 5 μm in thickness, is formed on the first fluorescent layer only.

### Experimental Example 4

A reflecting layer of 150 μm in thickness is formed on a first substrate. A first adsorption preventing layer, which is made of an yttria material and is 5 μm in thickness, is formed on the reflecting layer. A first florescent layer of 40 μm in thickness is formed on the first adsorption preventing layer. A second florescent layer of 20 μm in thickness is formed on the bottom surface of a second substrate. A compound florescent layer, which is made of mixture of yttria and a fluorescent substance and is 5 μm in thickness, is formed on the first fluorescent layer only.

### Comparative Example

A reflecting layer of 150 μm in thickness is formed on a first substrate. A first fluorescent layer of 40 μm in thickness is formed on the reflecting layer. A second florescent layer of 20 μm in thickness is formed on the bottom surface of a second substrate.

### Evaluation of Brightness Uniformity of Surface Light Source Devices according to Experimental Examples 1 and 2 and Comparative Example

The brightness of the surface light source devices according to Experimental Examples 1 and 2 and Comparative Example is measured every 100 hours.

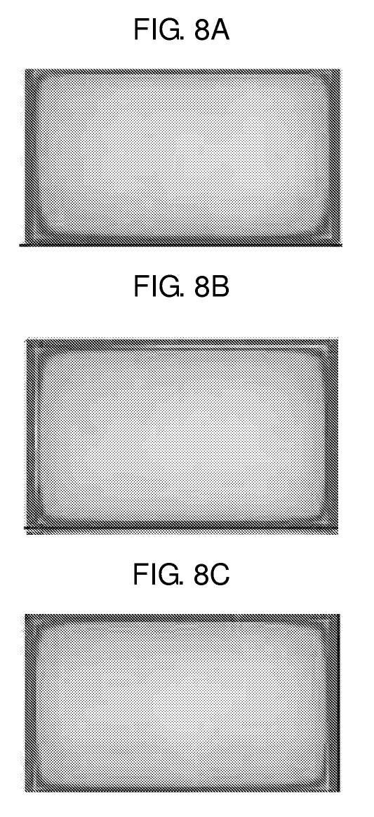

FIG. 8A is a picture showing the initial brightness of the surface light source device according to Experimental Example 1, FIG. 8B is a picture showing the initial brightness of the surface light source device according to Experimental Example 2, and FIG. 8C is a picture showing the initial brightness of the surface light source device according to Comparative Example.

As shown in FIGS. 8A, 8B and 8C, the initial brightness of all surface light source devices is uniform. That is, since there is little temperature difference in the discharge spaces when the surface light source devices are initially driven, the mercury gas is uniformly distributed in the discharge spaces.

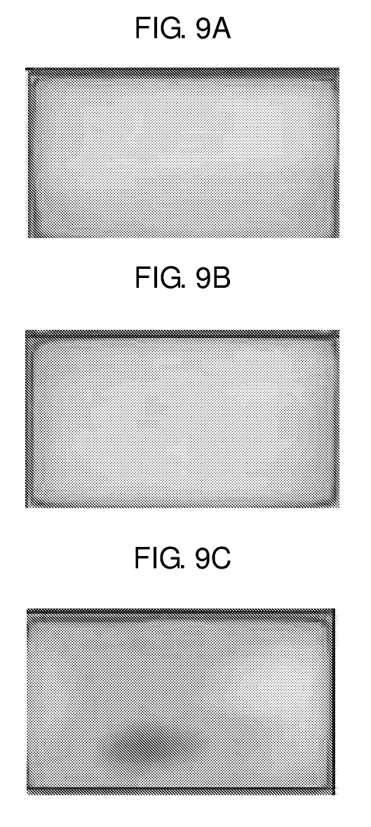

FIG. 9A is a picture showing the brightness of the surface light source device according to Experimental Example 1 after 100 hours, FIG. 9B is a picture showing the brightness of the surface light source device according to Experimental Example 2 after 100 hours, and FIG. 9C is a picture showing the brightness of the surface light source device according to Comparative Example after 100 hours.

As shown in FIGS. 9A and 9B, the surface light source devices according to Experimental Examples 1 and 2 have the uniform brightness even after 100 hours. However, as shown in FIG. 9C, the surface light source device according to Comparative Example partially has a non-lighting area. FIG. 9C proves that, in the surface light source device according to Comparative Example, which has no adsorption preventing layer and elution preventing layer, since the mercury gas is physically adsorbed to the fluorescent layers, the mercury gas is nonuniformly distributed in the discharge spaces. Further, it proves that, since the natrium ions contained in the substrate are eluted to the fluorescent layer, the blackening phenomenon is occurred.

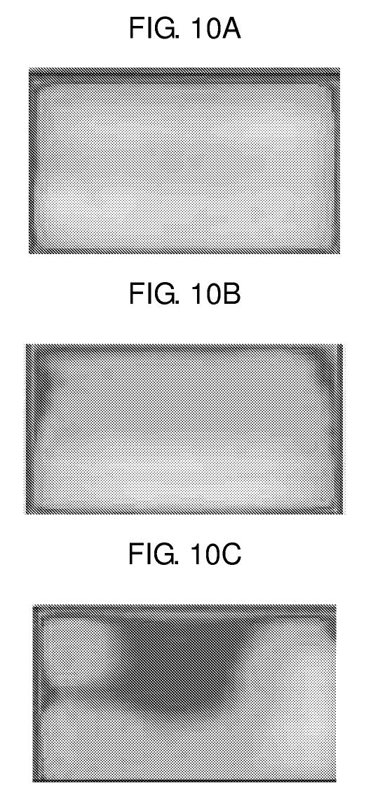

FIG. 10A is a picture showing the brightness of the surface light source device according to Experimental Example 1 after 200 hours, FIG. 10B is a picture showing the brightness of the surface light source device according to Experimental Example 2 after 200 hours, and FIG. 10C is a picture showing the brightness of the surface light source device according to Comparative Example after 200 hours.

As shown in FIGS. 10A and 10B, the surface light source devices according to Experimental Examples 1 and 2 still have the uniform brightness after 200 hours. That is, even though a temperature difference arises in the discharge spaces, since the mercury gas is prevented from being physically adsorbed to the fluorescent layers, the mercury gas is uniformly distributed in the discharge spaces. Further, since the elution preventing layer prevents the natrium ions contained in the substrate from being eluted to the fluorescent layer, the blackening phenomenon of the surface light source device is prevented. However, as shown in FIG. 10C, in the surface light source device according to Comparative Example, the non-lighting area is increased more.

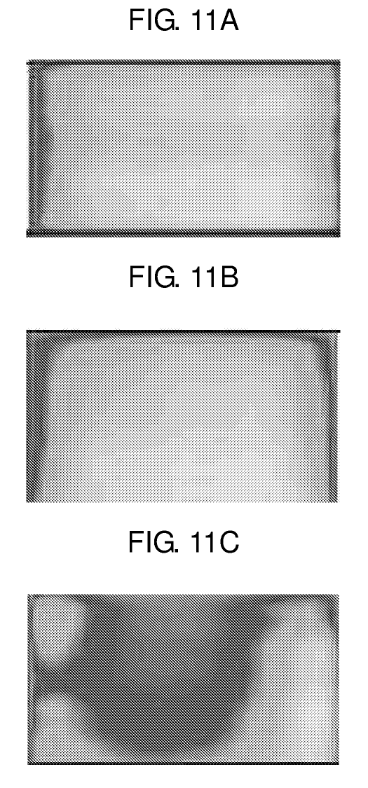

FIG. 11A is a picture showing the brightness of the surface light source device according to Experimental Example 1 after 300 hours, FIG. 11B is a picture showing the brightness of the surface light source device according to Experimental Example 2 after 300 hours, and FIG. 11C is a picture showing the brightness of the surface light source device according to Comparative Example after 300 hours.

As shown in FIGS. 11A and 11B, the surface light source devices according to Experimental Examples 1 and 2 still have the uniform brightness after 300 hours. However, as shown in FIG. 11C, in the surface light source device according to Comparative Example, the non-lighting area is increased more and more.

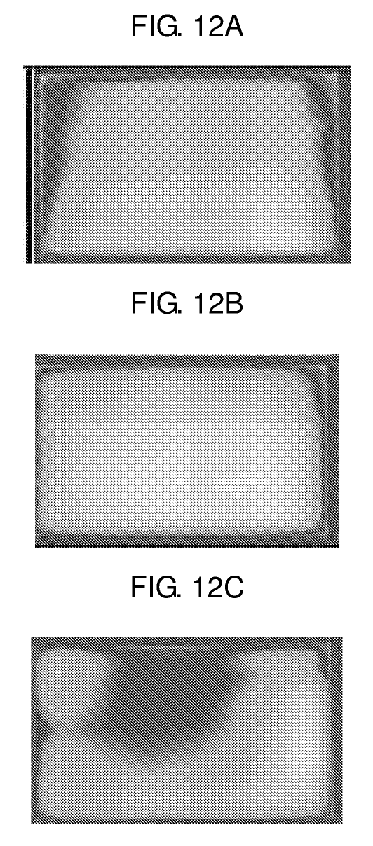

FIG. 12A is a picture showing the brightness of the surface light source device according to Experimental Example 1 after 500 hours, FIG. 12B is a picture showing the brightness of the surface light source device according to Experimental Example 2 after 500 hours, and FIG. 12C is a picture showing the brightness of the surface light source device according to Comparative Example after 500 hours.

As shown in FIGS. 12A and 12B, the surface light source devices according to Experimental Examples 1 and 2 still have the uniform brightness after 500 hours. That is, in the surface light source devices according to Experimental Examples 1 and 2, the initial brightness is nearly maintained after 500 hours. However, as shown in FIG. 12C, in the surface light source device according to Comparative Example, there are very large non-lighting areas.

From the above-described results, the adsorption preventing layer according to the embodiments of the present invention prevents the mercury gas from being physically adsorbed to the fluorescent layers. Further, the elution preventing layer prevents the natrium ions contained in the substrate from being eluted to the fluorescent layer, thereby preventing the blackening phenomenon of the surface light source device. Accordingly, even though the mercury gas flows towards the low temperature area of the discharge space on the influence of the temperature difference in the discharge spaces, the mercury gas is prevented from being physically adsorbed to the fluorescent layers. Consequently, as the mercury gas is uniformly distributed in the discharge spaces, the surface light source device according to the embodiments of the present invention can have the uniform brightness, even after it is driven for a long time.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A surface light source device, comprising:
a light source body having a first substrate and a second substrate between which a plurality of discharge spaces are formed, a discharge gas being provided into the discharge spaces;
a reflecting layer formed on an inner surface of the first substrate;
a first adsorption preventing layer formed on the reflecting layer, for preventing the discharge gas from being adsorbed to the reflecting layer;
a first fluorescent layer formed on the first adsorption preventing layer;
a second fluorescent layer formed on an inner surface of the second substrate; and
an electrode applying a discharge voltage to the discharge gas.

2. The surface light source device of claim 1, further comprising:
a second adsorption preventing layer formed on the first fluorescent layer, for preventing the discharge gas from being adsorbed to the first fluorescent layer; and
a third adsorption preventing layer formed on the second fluorescent layer, for preventing the discharge gas from being adsorbed to the second fluorescent layer.

3. The surface light source device of claim 2, wherein the second adsorption preventing layer has 20% or less thickness of a thickness of the first fluorescent layer.

4. The surface light source device of claim 2, wherein the second adsorption preventing layer is 10 nm to 10 μm in thickness.

5. The surface light source device of claim 2, wherein the first adsorption preventing layer has a greater thickness than the thickness of the second adsorption preventing layer.

6. The surface light source device of claim 2, wherein the first and second adsorption preventing layers are made of metal oxide.

7. The surface light source device of claim 6, wherein the metal oxide comprises at least any one selected from a group of alumina, zirconia, titania and yttria.

8. The surface light source device of claim 1, further comprising:
an elution preventing layer interposed between the second substrate and the second fluorescent layer, for preventing a metal contained in the second substrate from being eluted to the second fluorescent layer.

9. A surface light source device comprising:
a light source body having a first substrate and a second substrate between which a plurality of discharge spaces are formed, a discharge gas being provided into the discharge spaces;
a reflecting layer formed on an inner surface of the first substrate;
a compound fluorescent layer formed on at least any one of the reflecting layer and an inner surface of the second substrate, the compound fluorescent layer composed of a fluorescent substance and an adsorption preventing material; and
an electrode applying a discharge voltage to the discharge gas.

10. A backlight unit comprising:
a surface light source device, comprising a light source body having a first substrate and a second substrate between which a plurality of discharge spaces are formed, a discharge gas being provided into the discharge spaces, a reflecting layer formed on an inner surface of the first substrate, a first adsorption preventing layer formed on the reflecting layer, for preventing the discharge gas from being adsorbed to the reflecting layer, a first fluorescent layer formed on the first adsorption preventing layer, a second fluorescent layer formed on an inner surface of the second substrate, and an electrode applying a discharge voltage to the discharge gas;
a case for receiving the surface light source device;
an optical sheet interposed between the surface light source device and the case; and
an inverter for supplying the discharge voltage for driving the surface light source device to the electrode.
